(19) United States
(12) Patent Application Publication
(10) Pub. No.: US 2010/0154288 A1
(43) Pub. Date: Jun. 24, 2010

(54) ANIMAL TRAP WITH REPLACEABLE TRIGGER

(76) Inventor: Steven Frisch, Brooklyn, NY (US)

Correspondence Address: BERNARD MALINA, 444 MADISON AVENUE, 17TH FLOOR, NEW YORK, NY, 10022, US

(21) Appl. No.: 12/391,517

(22) Filed: Feb. 24, 2009

Related U.S. Application Data
(60) Provisional application No. 61/140,730, filed on Dec. 24, 2008.

(51) Int. Cl. A01M 23/30; A01M 23/00; A01M 1/14

(52) U.S. Cl. 43/81; 43/114

(57) ABSTRACT

An animal trap includes a base member, a spring-loaded pivotally mounted striker bail, a striker hold-down member, and a removable trigger member. The removable trigger member is pivotally mounted on the base member and includes a generally flat portion with upwardly directed flanges along defining peripheral edges. The upwardly directed flanges on the trigger member form a trough which may be filled with a non-drying, adhesive thereby forming an adhesive layer. The trigger member includes a catch portion which engages an end of the striker hold-down member. When a rodent touches the trigger member in an attempt to reach the bait, the rodent becomes ensnared by the adhesive layer. The motion of the rodent in an attempt to free itself moves the trigger member and causes the catch member to release the striker hold-down member thereby releasing the spring loaded striker bail which pivots to strike and kill the rodent.

### RELATED APPLICATIONS

The present application claims priority from Provisional Patent Application Ser. No. 61/140,730, filed Dec. 24, 2008, entitled “Animal Trap With Replaceable Trigger.”

### FIELD OF THE INVENTION

The present invention relates generally to the field of equipment for rodent and pest control and more particularly, to an animal trap with a replaceable trigger.

### BACKGROUND OF THE INVENTION

The field of traps for rodent control includes various examples of traps in which bait is placed on a bait member to attract a rodent. Movement of the bait member activates a spring-loaded bail which pivots to strike and kill the rodent.

During use, the bait often falls off the bait member or the bait is stolen or removed from the bait member by a rodent without activation of the trap.

In prior art traps, after the trap has been activated, the user typically disposes of the trap along with the remains of the rodent. While generally acceptable for use in individual households where a small quantity of traps are set, the need to dispose of the trap after use is costly and inconvenient for professional sanitarians who typically utilize a relatively large number of traps in a single industrial site.

The prior art includes glue traps which comprise a layer of adhesive to ensnare a rodent. The glue traps, at times, require a user to deal with a live rodent which has become ensnared.

### OBJECTS AND SUMMARY OF THE INVENTION

It is an object of the present invention is to provide an animal trap with a replaceable trigger which includes an adhesive layer to reduce the incidence of unwanted removal of the bait by a rodent without trap activation.

Another object of the present invention is to provide an animal trap with a replaceable trigger which reduces the incidence of the bait falling off the trap.

Another object of the present invention is to provide an animal trap with a replaceable trigger which includes an adhesive layer which prevents a rodent from escaping from the trap.

Another object of the present invention is to provide an animal trap with a replaceable trigger which includes an easily replaceable trigger member which facilitates continued reuse of the animal trap.

Yet another object of the present invention is to provide an animal trap with a replaceable trigger which includes a relatively small number of component parts which can be manufactured economically in volume resulting in a relatively low unit cost.

Other objects and a more complete understanding of the invention will be made clear hereinafter.

In accordance with the present invention, there is provided an animal trap with a removeable trigger which includes a base member, a spring-loaded pivotally mounted striker bail, a striker hold down member, and a removeable trigger member. The removable trigger member is pivotally mounted on the base member and includes a generally flat portion with upwardly directed flanges along defining peripheral edges. The trigger member includes a pivot portion which removably snaps onto a pivot rod which is mounted on the base. The pivot portion enables the trigger member to pivot freely relative to the base and to be easily removed and replaced with a like member after a rodent has been trapped and killed.

The upwardly directed flanges on the trigger member form a trough which may be filled with a non-drying, adhesive thereby forming an adhesive layer.

The trigger member includes a catch portion which engages an end of the striker hold-down member.

When a rodent touches the trigger member in an attempt to reach the bait, the rodent becomes ensnared by the adhesive layer. The motion of the rodent in an attempt to free itself moves the trigger member and causes the catch member to release the striker hold-down member thereby releasing the spring loaded striker bail which pivots to strike and kill the rodent.

The user can easily grasp the base and the trigger member, remove the trigger member and the remains of the rodent and replace the trigger member with a new trigger member.

Additional objects, features and advantages of the invention will be apparent from the following detailed description when taken in conjunction with the accompanying drawings.

### BRIEF DESCRIPTION OF THE DRAWINGS

FIG. 1 is an overall perspective view of an animal trap with a replaceable trigger according to the present invention;

FIG. 2 is a side elevation view of the animal trap of FIG. 1 with portions shown in section for clarity of illustration;

FIG. 3 is a perspective view of the trigger member shown removed from the trap of FIG. 1;

FIG. 4 is an elevation view taken along the line 4-4 of FIG. 3;

FIG. 5 is an overall perspective view of an alternative embodiment of the animal trap of FIG. 1;

FIG. 6 is a fragmentary cross-sectional view taken along the line 6-6 of FIG. 5; and

FIG. 7 is a fragmentary cross-sectional view similar to FIG. 6 showing another alternative embodiment of the invention.

Other objects and a more complete understanding of the invention will be made clear hereinafter.

### DETAILED DESCRIPTION OF THE INVENTION

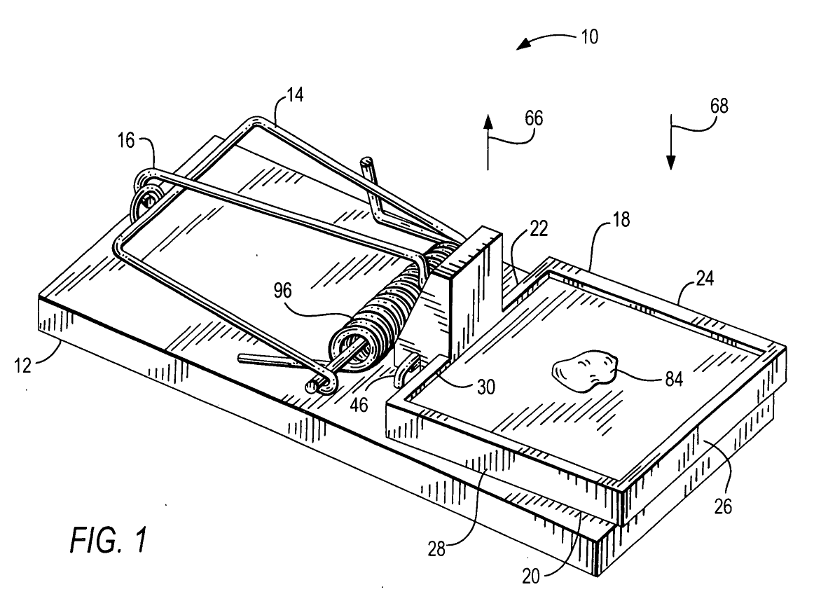

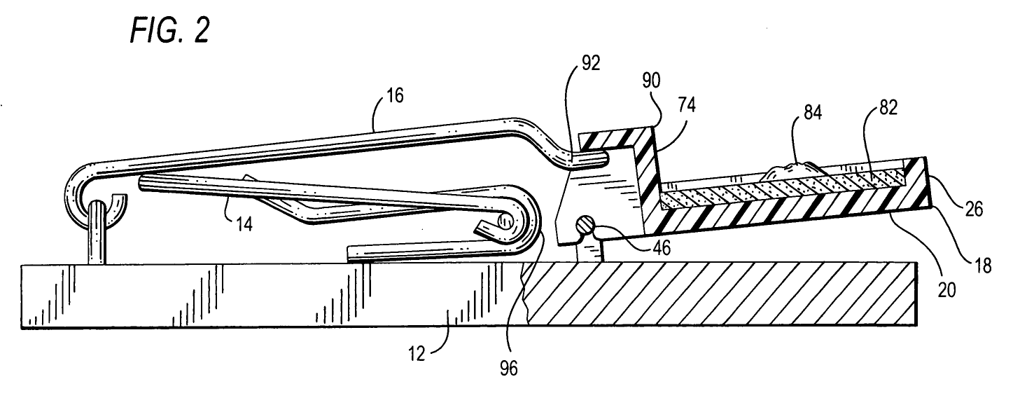

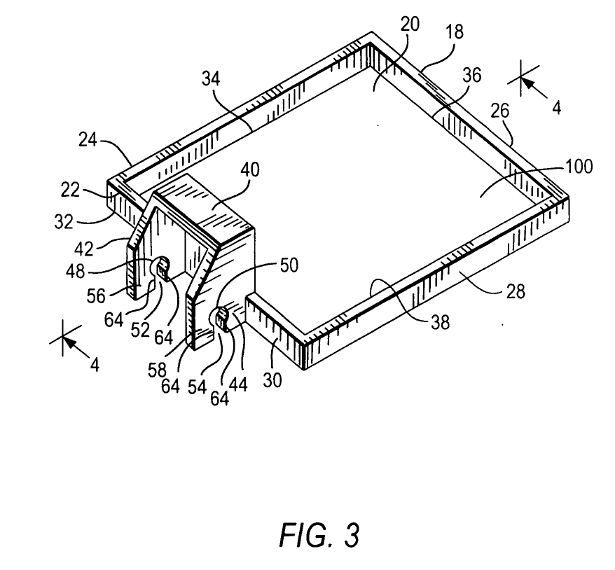

With reference to the drawings, there is shown in FIGS. 1-4 an animal trap with a removable trigger 10 made in accordance with the present invention which includes a base member 12, a spring-loaded pivotally mounted striker bail 14, a striker hold down member 16, and a removable trigger member 18. The removable trigger member 18 is pivotally mounted on the base member 12 and includes a generally flat portion 20 with upwardly directed flanges 22, 24, 26, 28, 30 along the defining peripheral edges 32, 34, 36, 38. The trigger member 18 includes a pivot portion 40 which includes a pair of spaced apart wall portions 42, 43 which removably snap onto a pivot rod or staple 46 which is mounted on the base 14. The pivot portion 40 enables the trigger member 18 to pivot freely relative to the base member 12 and to be easily removed and replaced with a like trigger member 18 during use. The pair of spaced apart identical side wall portions 42, 44 integrally formed on the trigger member 18. The side wall portions 42, 44 each have a clearance hole 48, 50 which is slightly larger than the diameter of the staple 46 which projects from the base 14. The clearance holes 48, 50 enable the trigger member 18 to pivot freely relative to the staple 46 and the base 14. The sidewall portions 42, 44 each include a slot 52, 54 communicating with a clearance hole 48, 50. The slots 52, 54 have a width which is somewhat smaller than the diameter of the staple 46. The lower ends 56, 58, 60, 62 of the slots 52, 54 each include chamber portions 64.

The trigger member 18 is preferably formed of a moldable plastic material. The trigger member 18 can be removed from the base member 12 by manually grasping the trigger member 18 and pulling it away from the base member 12 in the direction shown by the arrow.

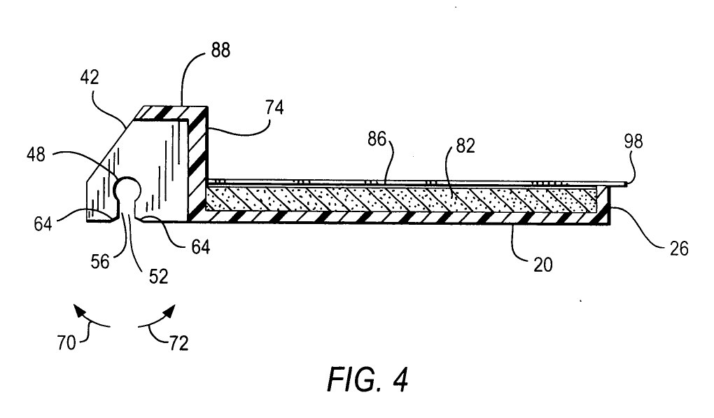

The chamfer portion facilitates the installation of a new trigger member 18 of identical configuration by pressing the new trigger member 18 onto the staple 46 in the direction shown by the arrow 68. The side walls flex in the direction shown by the arrows 70, 72 in FIG. 4 enabling the new trigger member 18 to snap onto the staple 46.

The upwardly directed flanges 22, 24, 26, 28, 30, the rear wall portion 74, and the flat portion 20 form a trough which may be filled with a non-drying adhesive thereby forming an adhesive layer 82. A piece of bait or attractant 84 may be placed on the adhesive layer 82.

A sheet of release paper 86 covers the adhesive layer 82 and the bait 84. The release paper 86 is removed prior to use.

The side wall portions 42, 44, the top wall portion 42, and the rear wall portion 74 form a catch portion 76 which engages the end 88 of the striker hold down member 16.

When a rodent touches the trigger member 18 in an attempt to eat the bait 84, the rodent becomes ensnared by the adhesive layer 82. The motion of the rodent in an attempt to free itself moves the trigger member 18 and causes the catch portion 76 to release the striker hold-down member 16 thereby releasing the spring loaded striker bail 14 which is urged by the spring 90 to strike and kill the rodent.

The user can easily grasp the base member 12 and the trigger member 18, remove the trigger member 18 and the remains of the rodent and replace the trigger member 18 with a new trigger member 18.

The striker-hold down member 16, the spring loaded bail 14, and the spring 96 are generally conventional in nature and have therefore not been described in detail.

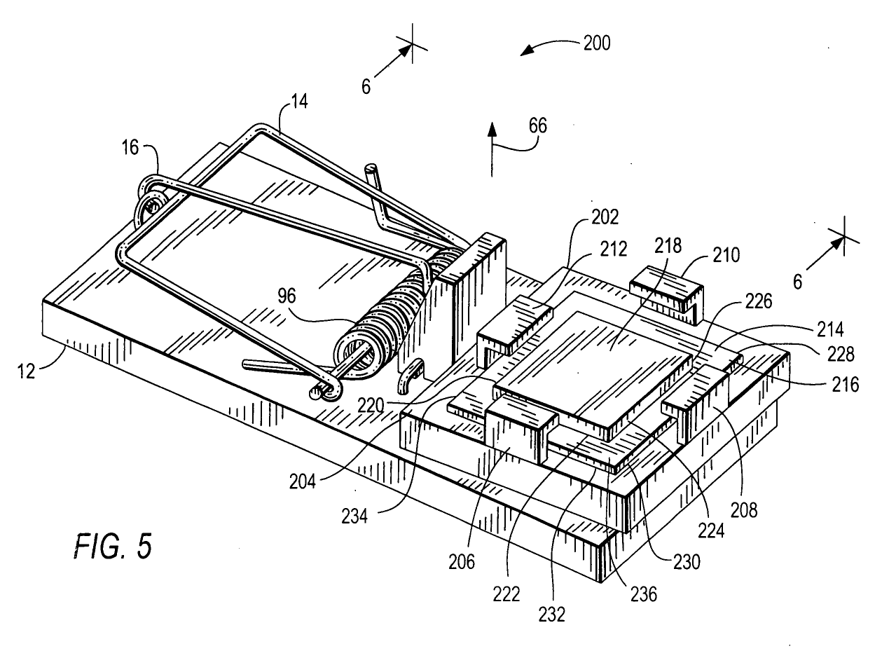

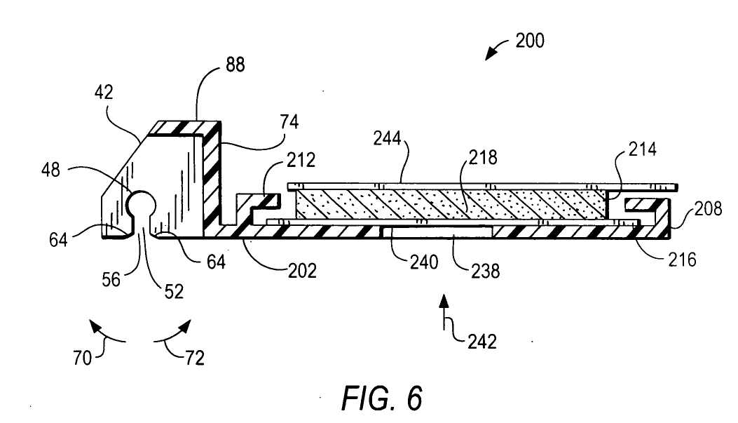

A second embodiment of the invention is shown in FIGS. 5-6. In the second embodiment of the invention 200, the removable trigger member 202 is generally similar to the removable trigger member 18 previously described with the exception that the upwardly directed flanges 22, 24, 26, 28, 30 have been eliminated. The top surface 204 of the removable trigger member 202 includes retaining flanges 206, 208, 210, 212. The retaining flanges 206, 208, 210, 212 removably retain a glue board 214 on the trigger member 202. The glue board 214 has a flexible cardboard substrate 216 and a layer of non-drying adhesive 218. The edges 220, 222, 224, 226 of the non-drying adhesive layer 218 are spaced away from the edges 228, 230, 232, 234 of the cardboard substrate 216 leaving a border 236 which engages the retaining flanges 206, 208, 210, 212 and which is free of adhesive.

The border 236 ensures that the glue board 214 will not adhere to the retaining flanges 206, 208, 210, 212. The removable trigger member 202 includes an aperture 238 which is best shown in FIG. 6. To remove the glue board 214 from the trigger member 202, the bottom 240 of the substrate 216 is pressed in an upward direction by the user in the direction shown by the arrow 242 in FIG. 6. The glue board 214 flexes past the flanges 206, 208, 210, 212 and the glue board 214 along with a trapped rodent can be easily removed from the trigger member 202.

The adhesive layer may be covered by a sheet of release paper 244 for protection prior to use.

In the second embodiment of the invention 200, the trigger member 202 may be removed from the trap 220 in the manner previously described in connection with the first embodiment of the invention 10 and which has been illustrated in FIGS. 1-4. The glue board 214 may be removed from the trigger member 202 as described above.

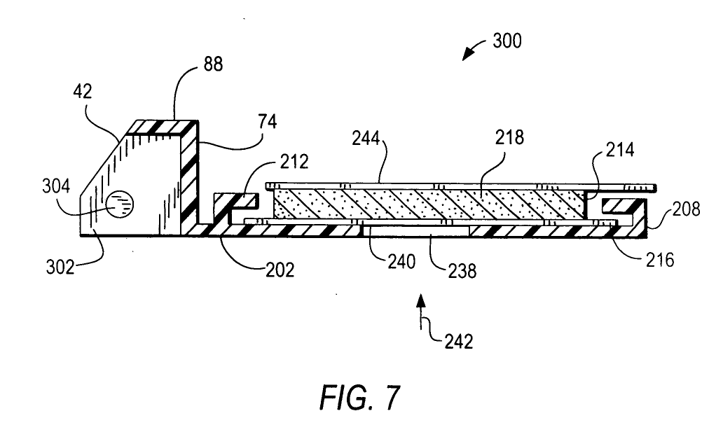

A third embodiment of the invention 300 is shown in FIG. 7. The third embodiment of the invention 300 is similar to the second embodiment of the invention 200 with the exception that the slots 52, 54 have been eliminated and the trigger member 302 is permanently and pivotally connected to the staple 46 on the base member 12 by 304. The glue board 214 is retained on the trigger member 302 and may be removed from the trigger member 304 in the manner described in connection with the second embodiment of the invention 200. The retaining flanges 206, 208, 210, 212 are as previously described.

In the second embodiment of the invention 200, the trigger member 202 along with the glue board 214 may be removed from the trap 200 or alternatively, the glue board 214 along may be removed from the trap 200 leaving the trigger member connected to the trap 200.

In the third embodiment of the invention 300, only the glue board 214 is removed from the trap 300 and the trigger member 302 remains connected to the trap 300.

The foregoing specific embodiments of the present invention as set forth in the specification herein are for illustrative purposes only. Various deviations and modifications may be made within the spirit and scope of this invention, without departing from a main theme thereof.

What is claimed is:

1. An animal trap with a replaceable trigger comprising:
a base;
a spring loaded striker bail pivotally mounted on said base;
a spring connecting said base and said striker bail;
a striker hold down member connected to said base;
a trigger member pivotally and removably connected to said base and in contact with said hold-down member to facilitate release of said striker bail responsive to motion of said trigger member; and
an adhesive layer disposed on said trigger member.

2. The animal trap as claimed in claim 1 further comprising:
a pivot rod mounted on said base; and
a snap-fit connection formed on said trigger member with said snap-fit connection removably and pivotally connecting said trigger member and said pivot rod.

3. The animal trap as claimed in claim 1 wherein said trigger member further comprises:
a trough portion with said adhesive layer disposed in said trough portion.

4. The animal trap as claimed in claim 1 further comprising:
a substrate member removably mounted on said trigger member with said adhesive layer disposed on said substrate member.

5. The animal trap as claims in claim 4 wherein said substrate member is flexible.

6. The animal trap as claimed in claim 5 wherein said trigger member further comprises:
an aperture portion disposed below said substrate member.

7. The animal trap as claimed in claim 4 further comprising:
a plurality of retaining flanges disposed on said trigger member and disposed retaining said substrate member on said trigger member.

8. An animal trap with a replaceable trigger comprising:
a base;
a spring-loaded striker bail, pivotally mounted on said base;
a spring connecting said base and said striker bail;
a striker hold-down member connected to said base;
a trigger support pivotally connected to said base and in contact with said hold-down member to facilitate release of said striker bail responsive to motion of said trigger support;
a trigger substrate removably mounted on said trigger support; and
an adhesive layer disposed on said trigger substrate.
